(19) United States
(12) Patent Application Publication
(10) Pub. No.: US 2021/0044519 A1
(43) Pub. Date: Feb. 11, 2021

(54) MULTILAYER NETWORK SYSTEM, CONTROLLER, CONTROL METHOD, AND NON-TRANSITORY COMPUTER READABLE MEDIUM

(71) Applicant: NEC Corporation, Tokyo (JP)

(72) Inventor: Osamu MATSUDA, Tokyo (JP)

(73) Assignee: NEC Corporation, Tokyo (JP)

(21) Appl. No.: 16/981,796

(22) PCT Filed: Oct. 29, 2018
(86) PCT No.: PCT/JP2018/040094

§ 371 Date: Sep. 17, 2020

(30) Foreign Application Priority Data
Mar. 19, 2018 (JP) 2018-050756

(51) Int. Cl. H04L 12/723; H04L 12/751

(52) U.S. Cl. CPC H04L 45/50; H04L 45/02

(57) ABSTRACT

A multilayer network system according to the present disclosure includes: a plurality of IP/MPLS routers (10); a transmission device (20) configured to connect the plurality IP/MPLS routers (10); and a controller (30) configured to control the transmission device (20). The controller (30) detects whether or not an MPLS path has been established between the IP/MPLS routers (10), determines, when it detects that the MPLS path has been established, a route for packets to which an MPLS label is added among packets which are transferred between the IP/MPLS routers (10) between which the MPLS path has been established, and configures the MPLS path in the transmission device (20) disposed on the determined route and sets the transmission devices (20) to transfer the packets to which the MPLS label is added based on the MPLS label.

### TECHNICAL FIELD

The present disclosure relates to a multilayer network system, a controller, a control method, and a non-transitory computer readable medium.

### BACKGROUND ART

Conventionally, a multilayer network configured of an IP (Internet Protocol)/MPLS (Multi Protocol Label Switching) network composed of an IP/MPLS router and a transmission network composed of a transmission device has been known.

Hereinbelow, a method of controlling a multilayer network in a multilayer network system according to a related art is described with reference to FIGS. 6 to 9. Note that the multilayer network systems shown in FIGS. 6 to 9 have in common the following assumptions.

Four IP/MPLS routers 10 (IP/MPLS routers 10A, 10B, 10C, and 10D) and four transmission devices 20 (transmission devices 20V, 20W, 20X, and 20Y are provided.

Using an inter-device data interface, the transmission device 20V and the IP/MPLS router 10A, the transmission device 20W and the IP/MPLS router 10B, the transmission device 20X and the IP/MPLS router 10C, and the transmission device 20Y and the IP/MPLS router 10D are connected to each other, respectively.

Using a transmission line, the transmission devices 20V and 20W, the transmission devices 20V and 20X, the transmission devices 20W and 20Y, and the transmission devices 20X and 20Y are connected to each other, respectively.

In a Related Art 1 shown in FIG. 6, the IP/MPLS protocol is also installed to the transmission devices 20V, 20W, 20X, and 20Y. Accordingly, all of the devices (the four IP/MPLS routers 10 and the four transmission devices 20) in the multilayer network execute the IP/MPLS protocol. Therefore, the transmission devices 20V, 20W, 20X, and 20Y transfer packets by performing IP routing.

Note that in the Related Art 1, the transmission devices 20V, 20W, 20X, and 20Y also execute the IP/MPLS protocol. Therefore, by using the IP/MPLS signaling interface, the IP/MPLS router 10A and the transmission device 20V, the IP/MPLS router 10B and the transmission device 20W, the IP/MPLS router 10C and the transmission device 20X, the IP/MPLS router 10D and the transmission device 20Y, the transmission devices 20V and 20W, the transmission devices 20V and 20X, the transmission devices 20W and 20Y, and the transmission devices 20X and 20Y are connected to each other, respectively.

In a Related Art 2 shown in FIG. 7, a link that directly connects the IP/MPLS routers 10A, 10B, 10C, and 10D with each other is configured using the transmission devices 20V, 20W, 20X, and 20Y. Therefore, the IP/MPLS routers 10A, 10B, 10C, and 10D are connected to the transmission devices 20V, 20W, 20X, and 20Y, respectively, by using the inter-device data interfaces for the number of IP/MPLS routers 10 that are opposed to each of the IP/MPLS routers 10A, 10B, 10C, and 10D (three routers in the example shown in FIG. 7). Thus, all of the IP/MPLS routers 10A, 10B, 10C, and 10D are controlled.

Note that in the Related Art 2, only the IP/MPLS routers 10A, 10B, 10C, and 10D execute the IP/MPLS protocol. Therefore, by using the IP/MPLS signaling interface, the IP/MPLS routers 10A and 10B, the IP/MPLS routers 10A and 10C, the IP/MPLS routers 10A and 10D, the IP/MPLS routers 10B and 10C, the IP/MPLS routers 10B and 10D, and the IP/MPLS routers 10C and 10D are connected to each other, respectively.

In a Related Art 3 shown in FIG. 8, a VLAN (Virtual Local Area Network) is configured of the transmission devices 20V, 20W, 20X, and 20Y. VLAN ID is used for the connection between the IP/MPLS routers 10A, 10B, 10C, and 10D and the transmission devices 20V, 20W, 20X, and 20Y. Therefore, the transmission devices 20V, 20W, 20X, and 20Y transfer packets in accordance with the settings of the VLAN.

Note that the mode of connection using the IP/MPLS signaling interface in the Related Art 3 is the same as that in the Related Art 2.

In a Related Art 4 shown in FIG. 9, a controller 90 for controlling the transmission devices 20V, 20W, 20X, and 20Y is provided (see, for example, Patent Literature 1) and each of the transmission devices 20V, 20W, 20X, and 20Y is connected to the controller 90 using a device-setting interface. The IP/MPLS protocol is executed between each of the IP/MPLS routers 10A, 10B, 10C, and 10D and the controller 90. In more detail, the controller 90 communicates with the IP/MPLS routers 10A, 10B, 10C and 10D and recognizes connection points with the IP/MPLS routers 10A, 10B, 10C, and 10D for which routes should be set. Then, the controller 90 determines the routes within the transmission network based on the recognized connection points and configures the MPLS path in each of the transmission devices 20V, 20W, 20X, and 20Y in order to realize the determined paths. Accordingly, the transmission devices 20V, 20W, 20X, and 20Y transfer packets in accordance with an MPLS label added to the packets.

Note that in the Related Art 4, the controller 90 also executes the IP/MPLS protocol. Therefore, by using the IP/MPLS signaling interface, each of the IP/MPLS routers 10A, 10B, 10C, and 10D is connected to the controller 90.

### CITATION LIST

### Patent Literature

Patent Document 1: International Patent Publication No. WO2013/038987

### SUMMARY OF INVENTION

### Technical Problem

However, the above-described Related Arts 1, 2, 3, and 4 have the following problems, respectively.

In the Related Art 1 shown in FIG. 6, the IP/MPLS protocol is also installed to the transmission devices 20V, 20W, 20X, and 20Y. Therefore, the Related Art 1 has a problem that the transmission devices 20V, 20W, 20X, and 20Y become high in cost.

In the Related Art 2 shown in FIG. 7, each of the IP/MPLS routers 10A, 10B, 10C, and 10D needs the inter-device data interface for the number of IP/MPLS routers 10 that are opposed thereto (three routers in the example shown in FIG. 7). Therefore, the Related Art 2 has a problem that the IP/MPLS routers 10A, 10B, 10C, and 10D become high in cost.

The Related Art 3 shown in FIG. 8 has a problem that the IP/MPLS routers 10A, 10B, 10C, and 10D need to manage the VLAN. Further, the number of VLAN IDs used between the IP/MPLS routers 10A, 10B, 10C, and 10D and the transmission devices 20V, 20W, 20X, and 20Y is limited to around 4,000. Therefore, the Related Art 3 also has a problem that the construction and the operation of the network become complicated.

In the Related Art 4 shown in FIG. 9, the controller 90 has functions for operating as the IP/MPLS router 10 like the IP/MPLS routers 10A, 10B, 10C, and 10D, and performs the protocol processing by using the functions. The functions for operating as the IP/MPLS router 10 include a routing protocol (such as OSPF (Open Shortest Path First)) and an MPLS signaling (such as RSVP (Resource Reservation Protocol). Therefore, the Related Art 4 has a problem that it is difficult to apply it to a large-scale network since the processing performance of the controller 90 becomes a restraint. Further, in the Related Art 4, since the controller 90 is included in the IP/MPLS network, there is a problem that the operation becomes complicated compared to the case where the IP/MPLS network is configured of only the IP/MPLS routers 10A, 10B, 10C, and 10D.

Table 1 shown below summarizes the problems of the Related Arts 1 to 4. Note that in Table 1, the centralized protocol processing refers to centralized processing performed on a plurality of IP/MPLS routers 10 such as that performed by the controller 90 of the Related Art 4.

TABLE 1

| | Cost of | | | Centralized |
|---|---|---|---|---|
| | transmission | Cost of | | protocol |
| | device | router | VLAN | processing |
| Related Art 1 | High | Low | Not required | Not required |
| | x | ∘ | ∘ | ∘ |
| Related Art 2 | Low | High | Not required | Not required |
| | ∘ | ∘ | ∘ | ∘ |
| Related Art 3 | Low | Low | Used | Not required |
| | ∘ | x | x | ∘ |
| Related Art 4 | Low | Low | Not required | Required |
| | ∘ | x | ∘ | x |

As shown in Table 1, the Related Arts 1 to 4 each has one of the problems that the cost of the transmission device 20 becomes high, the cost of the IP/MPLS router 10 becomes high, VLAN is used, or centralized protocol processing is required, and none of the Related Arts were free of any of these problems.

An object of the present disclosure is to provide a multilayer network system, a controller, a control method, and a non-transitory computer readable medium that can solve the aforementioned problem and control a multilayer network without having to use a VLAN and centralized protocol processing and while keeping the IP/MPLS router and the transmission device from becoming high in cost.

### Solution to Problem

A multilayer network system according to an aspect includes:

a plurality of IP (Internet Protocol)/MPLS (Multi Protocol Label Switching) routers;

a transmission device configured to connect the plurality IP/MPLS routers; and

a controller configured to control the transmission device, in which the controller

detects whether or not an MPLS path has been established between the IP/MPLS routers,

determines, when it detects that the MPLS path has been established, a route for packets to which an MPLS label is added among packets which are transferred between the IP/MPLS routers between which the MPLS path has been established, and

configures the MPLS path in the transmission devices disposed on the determined route and sets the transmission devices to transfer the packets to which the MPLS label is added based on the MPLS label.

A controller according to another aspect configured to control a transmission device that connects a plurality of IP (Internet Protocol)/MPLS (Multi Protocol Label Switching) routers, the controller including:

a transceiver; and

a processor coupled to the transceiver, in which the processor is configured to

detect whether or not an MPLS path has been established between the IP/MPLS routers,

determine, when it detects that the MPLS path has been established between the IP/MPLS routers, a route for packets to which an MPLS label is added among packets which are transferred between the IP/MPLS routers between which the MPLS path has been established, and

configure the MPLS path in the transmission devices disposed on the determined route and set the transmission devices to transfer the packets to which the MPLS label is added based on the MPLS label.

A control method according to further another aspect implemented by a controller configured to control a transmission device that connects a plurality of IP (Internet Protocol)/MPLS (Multi Protocol Label Switching) routers, the method including the steps of:

detecting whether or not an MPLS path has been established between the IP/MPLS routers;

determining, when it is detected that the MPLS path has been established, a route for packets to which an MPLS label is added among packets which are transferred between the IP/MPLS routers between which the MPLS path has been established; and

configuring the MPLS path in the transmission devices disposed on the determined route and setting the transmission devices to transfer the packets to which the MPLS label is added based on the MPLS label.

A non-transitory computer readable medium according to another example aspect storing a program for causing a computer that acts as a controller configured to control a transmission device that connects a plurality of IP (Internet Protocol)/MPLS (Multi Protocol Label Switching) routers to execute the processes of:

detecting whether or not an MPLS path has been established between the IP/MPLS routers;

determining, when it is detected that the MPLS path has been established, a route for packets to which an MPLS label is added among packets which are transferred between the IP/MPLS routers between which the MPLS path has been established; and

configuring the MPLS path in the transmission devices disposed on the determined route and setting the transmission device to transfer the packets to which the MPLS label is added based on the MPLS label.

### Advantageous Effects of Invention

According to the aforementioned aspects, an effect of providing a multilayer network system, a controller, a control method, and a non-transitory computer readable medium that can control a multilayer network without having to use a VLAN and centralized protocol processing and while keeping the IP/MPLS router and the transmission device from becoming high in cost can be obtained.

### BRIEF DESCRIPTION OF DRAWINGS

FIG. 1 is a diagram showing an example of a configuration of a multilayer network system according to an example embodiment;

FIG. 2 is a sequence diagram showing an example of operations of IP/MPLS routers up to creation of a routing table in the multilayer network system according to the example embodiment;

FIG. 3 is a sequence diagram showing an example of operations performed in establishing an MPLS path between the IP/MPLS routers in the multilayer network system according to the example embodiment;

FIG. 4 is a diagram showing an example of a state in which the MPLS path is established in the multilayer network system according to the example embodiment;

FIG. 5 is a block diagram showing an example of a structure of a controller according to the example embodiment;

FIG. 6 is an example of a configuration of a multilayer network system according to the Related Art 1;

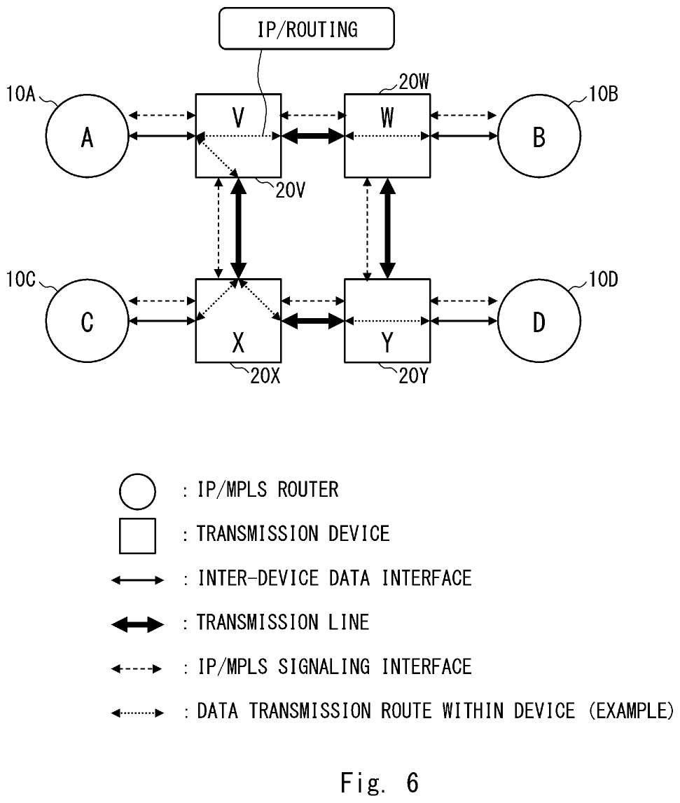

FIG. 7 is an example of a configuration of a multilayer network system according to the Related Art 2;

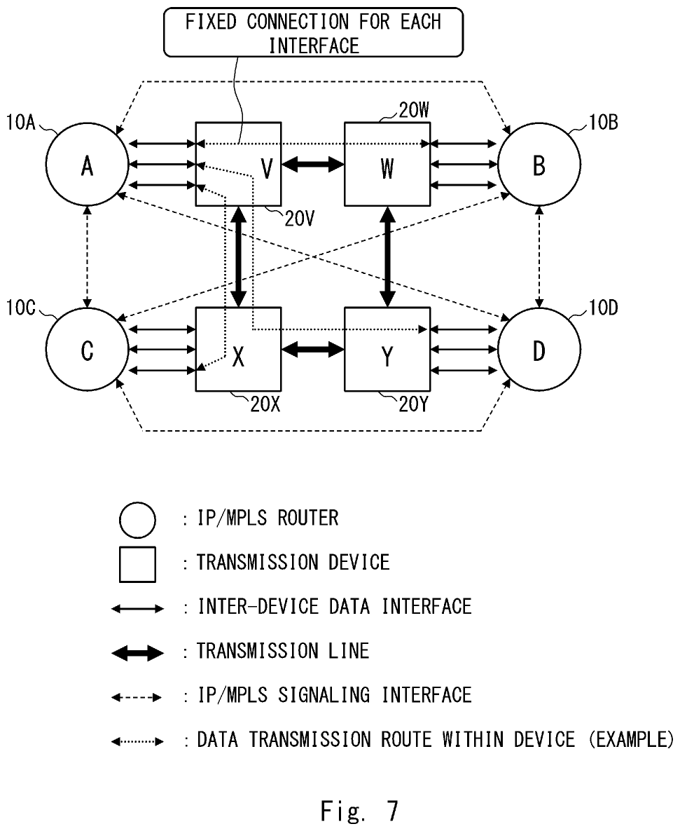

FIG. 8 is an example of a configuration of a multilayer network system according to the Related Art 3; and

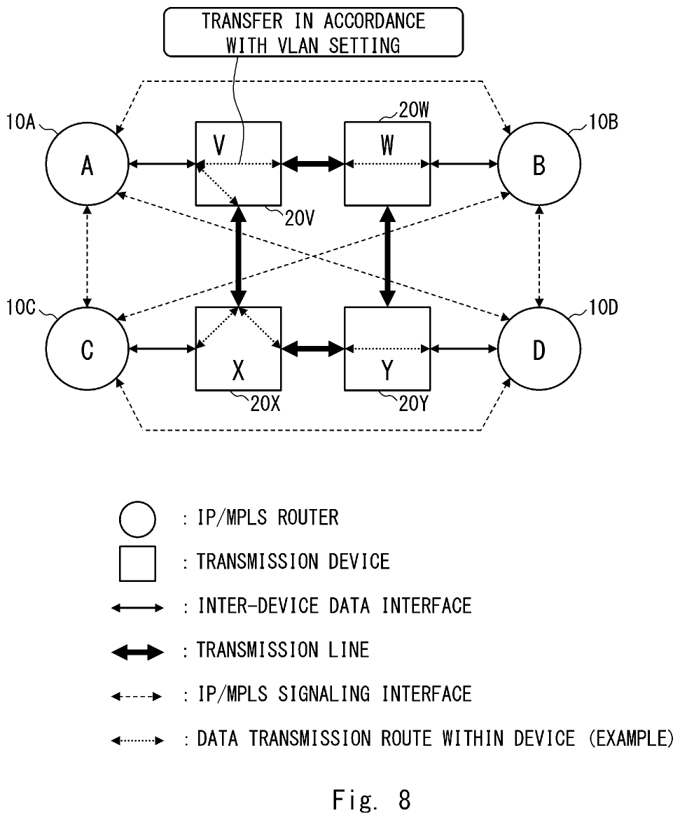

FIG. 9 is an example of a configuration of a multilayer network system according to the Related Art 4.

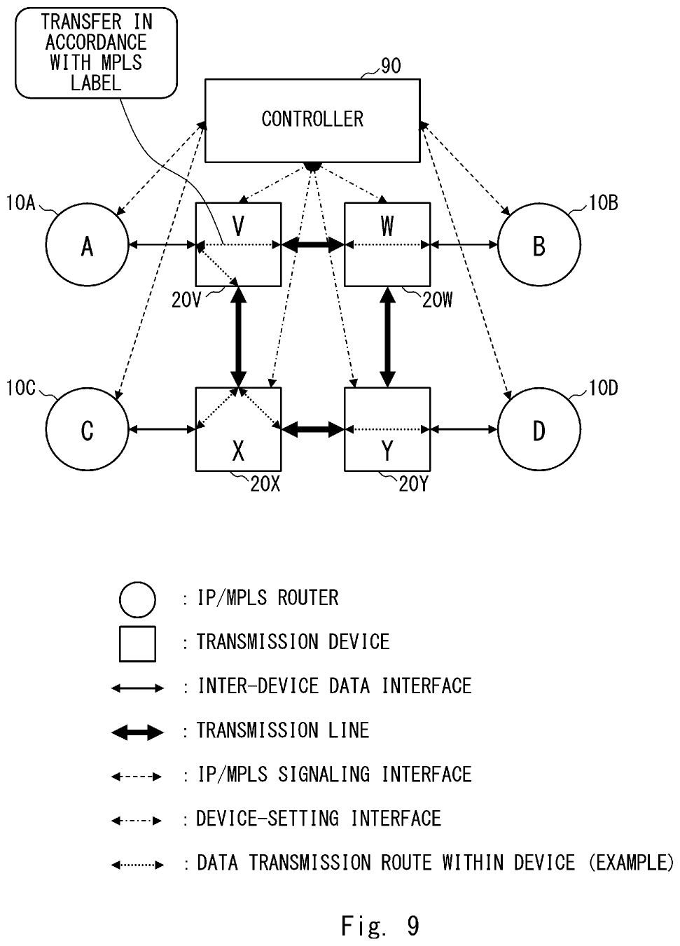

### DESCRIPTION OF EMBODIMENTS

Hereinafter, embodiments of the present disclosure will be described with reference to the drawings. For clarifying the explanation, the following description and the drawings are partially omitted and simplified where appropriate. The same symbols are assigned to the same elements in the drawings and duplicated explanations thereof are omitted as appropriate.

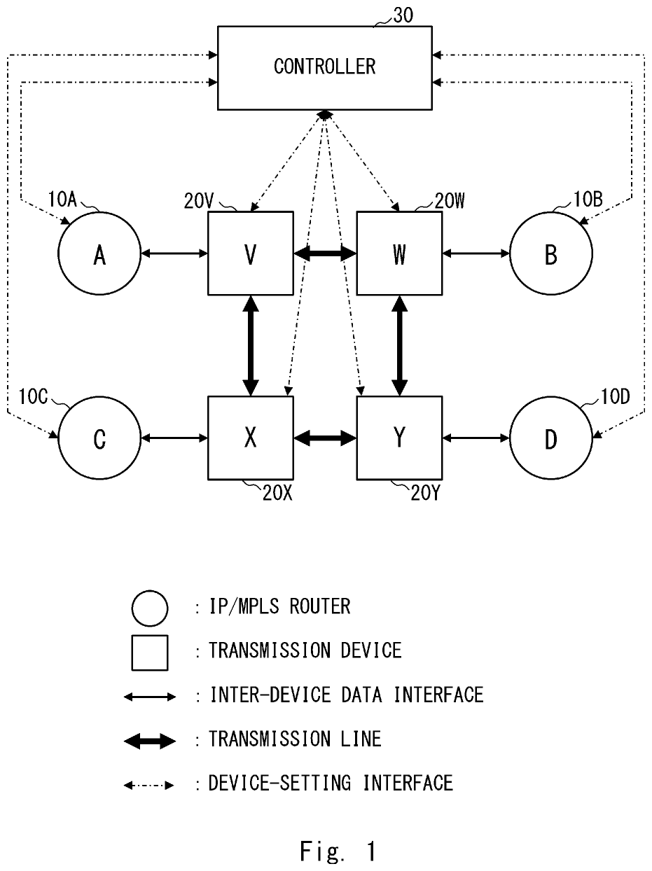

First, a configuration of a multilayer network system according to an example embodiment is described with reference to FIG. 1.

As shown in FIG. 1, the multilayer network system according to this example embodiment includes four IP/MPLS routers 10 (the IP/MPLS routers 10A, 10B, 10C, and 10D), four transmission devices 20 (the transmission devices 20V, 20W, 20X, and 20Y), and a controller 30. Note that the numbers of the IP/MPLS routers 10 and transmission devices 20 shown in FIG. 1 are merely examples and are not to be limited thereto. The number of the IP/MPLS routers 10 may be any number as long as it is a plural number, and the number of the transmission devices 20 may be any number as long as it is one or more.

The IP/MPLS routers 10A, 10B, 10C, and 10D configure the IP/MPLS network.

The transmission devices 20V, 20W, 20X, and 20Y configure the transmission line network and connects the IP/MPLS routers 10A, 10B, 10C, and 10D.

The controller 30 controls the transmission devices 20V, 20W, 20X, and 20Y.

Next, operation of the multilayer network system according to this example embodiment is described.

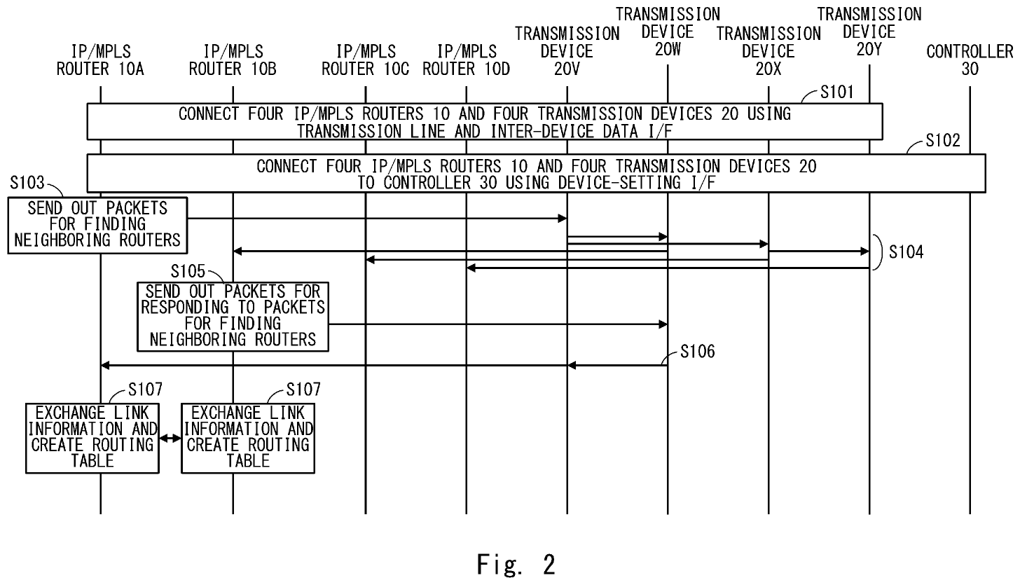

First, operations of the IP/MPLS routers 10A, 10B, 10C, and 10D up to creation of a routing table are described with reference to FIG. 2.

As shown in FIG. 2, first, a user connects the IP/MPLS routers 10A, 10B, 10C, and 10D and the transmission devices 20V, 20W, 20X, and 20Y using a transmission line and an inter-device data interface (Step S101). Specifically, the user connects the transmission device 20V and the IP/MPLS router 10A, the transmission device 20W and the IP/MPLS router 10B, the transmission device 20X and the IP/MPLS router 10C, and the transmission device 20Y and the IP/MPLS router 10D, respectively, using the inter-device data interface. Further, the user connects the transmission devices 20V and 20W, the transmission devices 20V and 20X, the transmission devices 20W and 20Y, and the transmission devices 20X and 20Y, respectively, using the transmission line.

Further, the user connects each of the transmission devices 20V, 20W, 20X, and 20Y and the IP/MPLS routers 10A, 10B, 10C, and 10D to the controller 30 using a device-setting interface (Step S102).

Here, it is assumed that the transmission devices 20V, 20W, 20X, and 20Y operate as the Ethernet (registered trademark) switch in the initial state.

Further, the IP/MPLS routers 10A, 10B, 10C, and 10D are set as to whether or not the MPLS is to be used as regards each of their own interfaces. Here, it is assumed that the IP/MPLS routers 10A, 10B, 10C, and 10D are set to use the MPLS as regards the inter-device data interface that is connected to the transmission device 20.

The IP/MPLS router 10A is mutually connected to other IP/MPLS routers 10 via the transmission devices 20V, 20W, 20X, and 20Y through the processing of Step S101. When the IP/MPLS router 10A is mutually connected to other IP/MPLS routers 10, it performs processing for finding the neighboring IP/MPLS routers 10 in order to use the routing protocol. Specifically, the IP/MPLS router 10A sends out packets for finding neighboring routers to the transmission device 20V in order to find the neighboring IP/MPLS routers 10 (Step S103).

When the packets for finding neighboring routers are sent out from the IP/MPLS router 10A, the transmission devices 20V, 20W, 20X, and 20Y transfer the packets for finding neighboring routers to all other IP/MPLS routers 10B, 10C, and 10D (Step S104). Specifically, the transmission device 20V transfers the packets for finding neighboring routers to the transmission devices 20W and 20X, the transmission device 20W transfers the packets for finding neighboring routers to the IP/MPLS router 10B, the transmission device 20X transfers the packets for finding neighboring routers to the IP/MPLS router 10C and the transmission device 20Y, and the transmission device 20Y transfers the packets for finding neighboring routers to the IP/MPLS router 10D. Note that in the example shown in FIG. 2, the transmission route from the transmission device 20V to the transmission device 20Y is transmission devices 20V→20X→20Y, however, the route may be the transmission devices 20V→20W→20Y.

Hereinbelow, as an example, operation of the IP/MPLS router 10B when it receives the packets for finding neighboring routers from the IP/MPLS router 10A is described.

When the IP/MPLS router 10B receives the packets for finding neighboring routers from the IP/MPLS router 10A, it sends out packets for responding to the packets for finding neighboring routers to the transmission device 20W in response to the packets for finding neighboring routers (Step S105).

When the packets for responding to the packets for finding neighboring routers are sent out from the IP/MPLS router 10B, the transmission devices 20W and 20V transfer the packets for responding to the packets for finding neighboring routers to the IP/MPLS router 10A (Step S106). Specifically, the transmission device 20W transfers the packets for responding to the packets for finding neighboring routers to the transmission device 20V and the transmission device 20V transfers the packets for responding to the packets for finding neighboring routers to the IP/MPLS router 10A.

When the IP/MPLS router 10A receives the packets for responding to the packets for finding neighboring routers from the IP/MPLS router 10B, the IP/MPLS routers 10A and 10B exchange the link information (the interface information) and create a routing table based on the exchanged link information using the routing protocol (Step S107). The routing table is a table in which a destination IP address and a next hop which is a transfer destination when transferring a packet having the destination IP address are associated with each other. At this time, the routing table of the IP/MPLS router 10A is a table in which the destination IP address is the IP address of the IP/MPLS router 10B and the routing table of the IP/MPLS router 10B is a table in which the destination IP address is the IP address of the IP/MPLS router 10A.

Note that although not illustrated, the IP/MPLS routers 10C and 10D also send out the packets for responding to the packets for finding neighboring routers sent out from the IP/MPLS router 10A. Therefore, the IP/MPLS router 10A exchanges the link information with the IP/MPLS routers 10C and 10D as well. Thus, all of the IP/MPLS routers 10A, 10B, 10C, and 10D create the routing tables.

Further, although not illustrated, the IP/MPLS routers 10B, 10C, and 10D also send out the packets for finding neighboring routers and exchange the link information with the neighboring IP/MPLS routers 10. Accordingly, the routing table of each of the IP/MPLS routers 10A, 10B, 10C, and 10D become a table in which the destination addresses are the IP addresses of the three IP/MPLS routers 10 that are opposed to each of the IP/MPLS routers 10A, 10B, 10C, and 10D.

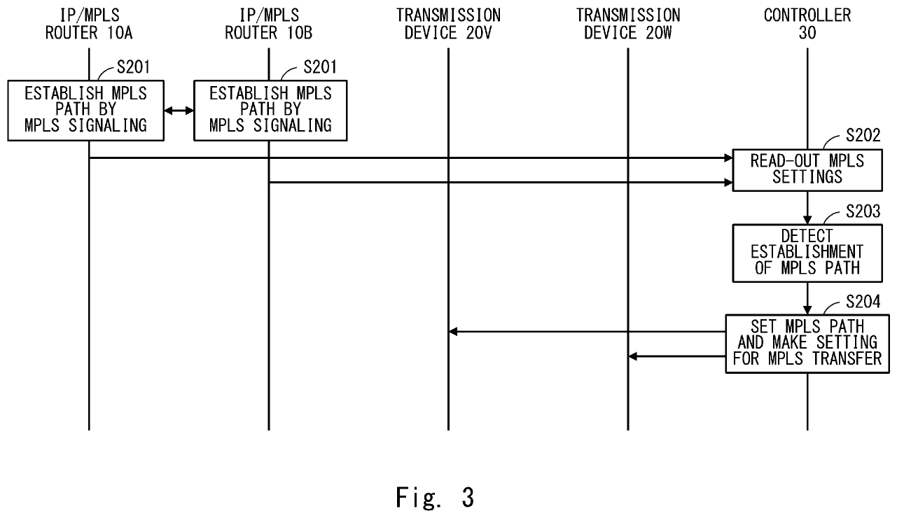

Next, operation in establishing the MPLS path (MPLS LSP (Label Switched Path)) between the IP/MPLS routers 10A and 10B is described with reference to FIG. 3.

As shown in FIG. 3, when establishing the MPLS path between the IP/MPLS router 10A and the IP/MPLS router 10B, the IP/MPLS router 10A performs MPLS signaling between the IP/MPLS router 10B and connects to the IP/MPLS router 10B using the IP/MPLS signaling interface. Accordingly, the MPLS path is established (Step S201).

The controller 30 reads out the settings of the MPLS path between the IP/MPLS routers 10A and 10B (Step S202). Note that the timing at which the controller 30 reads out the settings of the MPLS path between the IP/MPLS routers 10A and 10B can be a regular timing or a timing at which notifications of change of the state are received from the IP/MPLS routers 10A and 10B.

The controller 30 detects whether the MPLS path has been established between the IP/MPLS routers 10A and 10B based on the settings of the MPLS path for the IP/MPLS routers 10A and 10B. Here, it is detected that the MPLS path is established between the IP/MPLS routers 10A and 10B (Step S203).

When the controller 30 detects that the MPLS path has been established between the IP/MPLS routers 10A and 10B, it determines the route for the packets to which the MPLS label is added among the packets which are transferred between the IP/MPLS routers 10A and 10B, and configures the MPLS path in the transmission devices 20 disposed on the determined route and sets the transmission devices 20 to transfer the packets to which the MPLS label is added based on the MPLS label. Here, this setting is made for the transmission devices 20V and 20W (Step S204). Specifically, the controller 30 configures a LFIB (Label Forwarding Information Base) table (a label information table) for the transmission devices 20V and 20W. The LFIB table is a table in which an MPLS label, an MPLS label which replaces the MPLS label added to packets when transferring the packets, and a next hop which is a transfer destination when transferring the packets are associated with each other. Note that the controller 30 determines the route of the packets in accordance with the preset policy. This policy can be, for example, “not selecting a route that is congested”, “not selecting a route where a failure is occurring”, “selecting the shortest route”, “minimizing the number of devices disposed on the route”, and so on.

As described above, the IP/MPLS routers 10A and 10B are set so as to use the MPLS for the inter-device data interfaces to be connected to the transmission device 20.

Therefore, the packets to which the MPLS label is added among the packets which are transferred between the IP/MPLS routers 10A and 10B are transferred to the transmission devices 20V and 20W. Based on the LFIB table configured by the controller 30 and the MPLS label added to the packets, the transmission devices 20V and 20W transfer these packets.

Note that although not illustrated, the controller 30 reads out the setting of the MPLS path for the remaining IP/MPLS routers 10C and 10D, and detects whether or not the MPLS path is established between the IP/MPLS routers 10 other than the combination of the IP/MPLS routers 10A and 10B. The operation performed when it is detected that the MPLS path is established between any one of the combinations of the IP/MPLS routers 10 is the same as Step S204.

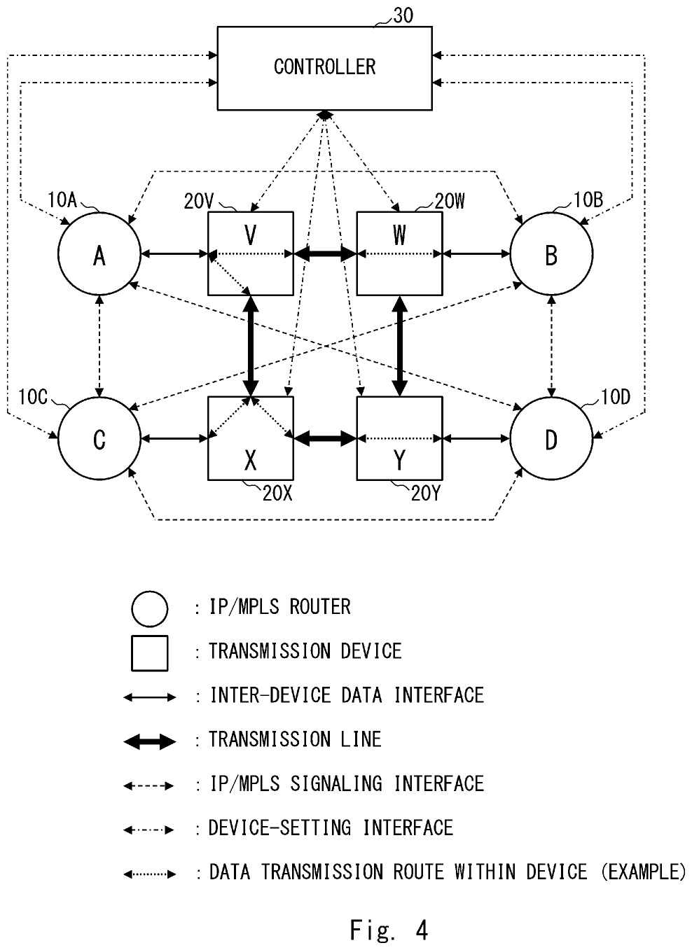

Next, the state in which the MPLS path has been established is described with reference to FIG. 4.

In the example shown in FIG. 4, the MPLS path is established between the IP/MPLS routers 10A and 10B, between the IP/MPLS routers 10A and 10C, between the IP/MPLS routers 10A and 10D, between the IP/MPLS routers 10B and 10C, between the IP/MPLS routers 10B and 10D, and between the IP/MPLS routers 10C and 10D, respectively. Therefore, the controller 30 detects establishment of these MPLS paths and configures the MPLS path in each of the transmission devices 20V, 20W, 20X, and 20Y.

In order to perform the aforementioned operations, the IP/MPLS routers 10, the transmission devices 20, and the controller 30 maintain the following table.

(A) IP/MPLS Router 10

Routing table: A table in which a destination IP address and a next hop which is the transfer destination when transferring a packet having the destination IP address are recorded in association with each other.

FIB (Forwarding Information Base) table (label information table): A table in which an MPLS label that is added when transferring a packet and a next hop which is the transfer destination when transferring the packet are recorded in association with each other.

LFIB table (label information table): A table in which an MPLS label, an MPLS label that replaces the MPLS label added to a packet when transferring the packet, and a next hop that is a transfer destination when transferring the packet are recorded in association with each other.

(B) Transmission Device 20

LFIB table (label information table): A table in which an MPLS label, an MPLS label that replaces the MPLS label added to a packet when transferring the packet, and a next hop that is a transfer destination when transferring the packet are recorded in association with each other.

(C) Controller 30

LSP table: A table in which a route of an MPLS path (MPLS LSP), the IP/MPLS router 10 which is a starting point router of the path, the IP/MPLS router 10 which is an ending point router of the path, and a label value of the MPLS label on the path are recorded.

LSP setting policy table: A table in which a policy according to which the MPLS path (MPLS LSP) is set for the transmission device 20 is recorded.

As described above, according to this example embodiment, the controller 30 detects whether the MPLS path has been established between the IP/MPLS routers 10. When the controller 30 detects that the MPLS path has been established, it determines the route for the packets to which the MPLS label is added among the packets which are transferred between the IP/MPLS routers 10 between which the MPLS path has been established, and configures the MPLS path in the transmission devices 20 disposed on the determined route and sets the transmission devices 20 to transfer the packets to which the MPLS label is added based on the MPLS label.

Accordingly, since the transmission device 20 does not perform the IP/MPLS protocol processing, it is low in cost.

Further, since the IP/MPLS router 10 does not have an inter-device interface for each of the IP/MPLS routers 10 that are opposed thereto, it is low in cost.

Further, since VALN is not used between the IP/MPLS router 10 and the transmission device 20, there is no need to manage the VLAN and furthermore, there is no restriction owing to the VLAN ID.

Further, the controller 30 does not need a function for operating as the IP/MPLS router 10 and does not perform the protocol processing using the function. Therefore, the processing performance of the controller 30 does not become a restraint in applying the controller 30 to a network of a large scale.

The aforementioned effects of the present example embodiment are shown below in Table 2.

TABLE 2

| | Cost of | | | Centralized |
|---|---|---|---|---|
| | transmission | | | protocol |
| | device | Cost of router | VLAN | processing |
| Example | Low | Low | Not required | Not required |
| Embodiment | ∘ | ∘ | ∘ | ∘ |

Therefore, according to the present example embodiment, it is possible to control the multilayer network without having to use the VALN and the centralized protocol processing and while keeping the IP/MPLS router and the transmission device from becoming high in cost.

Further, according to the present example embodiment, the operation of the IP/MPLS network configured of the IP/MPLS routers 10 may also be as it is. Further, the MPLS transmission based on the MPLS label is also used in the transmission network configured of the transmission devices 20.

Therefore, according to the present example embodiment, it is possible to perform traffic engineering across the whole multilayer network through the MPLS.

Further, according to the present example embodiment, the controller 30 determines the route of the packet to which the MPLS label is added in accordance with the preset policy. Therefore, when the controller 30 determines the route, the user can manipulate which route is to be taken in accordance with the policy. For example, when the user sets the policy of “not selecting a route that is congested”, the controller 30 can determine the MPLS path between the IP/MPLS routers 10A and 10B to be a path of, for instance, transmission devices 20V→20X→20Y→20W if the transmission line between the transmission devices 20V and 20W is congested.

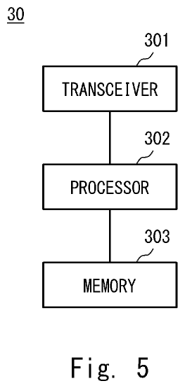

Next, the structure of the controller 30 according to the present example embodiment is described. FIG. 5 is a block diagram showing an example of the structure of the controller 30 according to the example embodiment.

As shown in FIG. 5, the controller 30 includes a transceiver 301, a processor 302, and a memory 303.

The transceiver 301 is used to communicate with the IP/MPLS router 10 or the transmission device 20. The transceiver 301 is realized in, for example a device-setting interface unit. For example, when the device-setting interface is the Ethernet interface, the device-setting interface unit is configured of the Ethernet transceiver. The transceiver 301 may include a plurality of transceivers. The transceiver 301 is coupled with the processor 302.

The memory 303 is configured to store a software module (a computer program) that includes a command group and data for performing the processing of the controller 30 described above. The memory 303 may be configured of, for example, a combination of a volatile memory and a non-volatile memory.

The processor 302 is configured to perform the processing of the controller 30 described above by reading out the software module (a computer program) from the memory 303 and executing it. The processor 302 may be, for example, a microprocessor, an MPU (Micro Processing Unit), or a CPU (Central Processing Unit). The processor 302 may include a plurality of processors.

The processor 302 executes one or a plurality of programs for causing a computer to perform the algorithm of the controller 30 described above. This program can be stored and provided to a computer using any type of non-transitory computer readable medium. Non-transitory computer readable media include any type of tangible storage medium. Examples of non-transitory computer readable media include magnetic storage media (such as floppy disks, magnetic tapes, hard disk drives, etc.), optical magnetic storage media (e.g. magneto-optical disks), CD-ROM (compact disc read only memory), CD-R (compact disc recordable), CD-R/W (compact disc rewritable), and semiconductor memories (such as mask ROM, PROM (programmable ROM), EPROM (erasable PROM), flash ROM, RAM (random access memory), etc.). The program may be provided to a computer using any type of transitory computer readable medium. Examples of transitory computer readable media include electric signals, optical signals, and electromagnetic waves. Transitory computer readable media can provide the program to a computer via a wired communication line such as electric wires and optical fibers or a wireless communication line.

Note that illustrations and explanations of the configurations of the IP/MPLS router 10 and the transmission device 20 are omitted. However, the configurations of the IP/MPLS router 10 and the transmission device 20 may be the same as the configuration of the controller 30 shown in FIG. 5.

The present disclosure has been described above with reference to the example embodiments. However, the present disclosure is not to be limited to the above example embodiments. Note that the configuration and details of the present disclosure can be changed in various ways within the scope of the present disclosure that can be understood by a skilled person.

This application is based upon and claims the benefit of priority from Japanese patent application No. 2018-050756, filed on Mar. 19, 2018, the disclosure of which is incorporated herein in its entirety by reference.

### REFERENCE SIGNS LIST

10A, 10B, 10C, 10D IP/MPLS ROUTERS
20V, 20W, 20X, 20Y TRANSMISSION DEVICES
30 CONTROLLER
301 TRANSCEIVER
302 PROCESSOR
303 MEMORY

1. A multilayer network system comprising:
a plurality of IP (Internet Protocol)/MPLS (Multi Protocol Label Switching) routers;
a transmission device configured to connect the plurality IP/MPLS routers; and
a controller configured to control the transmission device, wherein the controller detects whether or not an MPLS path has been established between the IP/MPLS routers, determines, when it detects that the MPLS path has been established, a route for packets to which an MPLS label is added among packets which are transferred between the IP/MPLS routers between which the MPLS path has been established, and
configures the MPLS path in the transmission devices disposed on the determined route and sets the transmission devices to transfer the packets to which the MPLS label is added based on the MPLS label.

2. The multilayer network system according to claim 1, wherein the controller is configured to determine the path based on a preset policy.

3. The multilayer network system according to claim 1, wherein the MPLS path is established between the IP/MPLS routers by performing an MPLS signaling between the IP/MPLS routers.

4. A controller configured to control a transmission device that connects a plurality of IP (Internet Protocol)/MPLS (Multi Protocol Label Switching) routers, the controller comprising:
a transceiver; and
a processor coupled to the transceiver, wherein the processor is configured to detect whether or not an MPLS path has been established between the IP/MPLS routers, determine, when it detects that the MPLS path has been established between the IP/MPLS routers, a route for packets to which an MPLS label is added among packets which are transferred between the IP/MPLS routers between which the MPLS path has been established, and
configure the MPLS path in the transmission devices disposed on the determined route and sets the transmission devices to transfer the packets to which the MPLS label is added based on the MPLS label.

5. A controller according to claim 4, wherein the processor is configured to determine the path based on a preset policy.

6. A control method implemented by a controller configured to control a transmission device that connects a plurality of IP (Internet Protocol)/MPLS (Multi Protocol Label Switching) routers, the method comprising the steps of:
detecting whether or not an MPLS path has been established between the IP/MPLS routers;
determining, when it is detected that the MPLS path has been established, a route for packets to which an MPLS label is added among packets which are transferred between the IP/MPLS routers between which the MPLS path has been established; and
configuring the MPLS path in the transmission devices disposed on the determined route and sets the transmission devices to transfer the packets to which the MPLS label is added based on the MPLS label.

7. The method according to claim 6, wherein in the step of determining the path, the path is determined based on a preset policy.

8. (canceled)

9. (canceled)
